(19) United States
(12) Patent Application Publication
(10) Pub. No.: US 2024/0144007 A1
(43) Pub. Date: May 2, 2024

(54) METHODS, APPARATUSES, DEVICE, AND MEDIUM FOR CONTRASTIVE LEARNING

(71) Applicant: Beijing Youzhuju Network Technology Co., Ltd., Beijing (CN)

(72) Inventors: Hao Wu, Beijing (CN); Boyan Zhou, Beijing (CN); Quan Cui, Beijing (CN); Cheng Yang, Beijing (CN)

(21) Appl. No.: 18/472,605

(22) Filed: Sep. 22, 2023

(30) Foreign Application Priority Data
Oct. 31, 2022 (CN) 202211352406.7

(51) Int. Cl. G06N 3/08

(52) U.S. Cl. CPC G06N 3/08

(57) ABSTRACT

A method of contrastive learning comprises: determining, based on a model construction criterion, a first encoder for a first modality and a second encoder for a second modality; constructing a first contrastive learning model, the first contrastive learning model comprising the first encoder and a third encoder for the second modality, and a model capacity of the third encoder being greater than a model capacity of the second encoder; performing pre-training of the first contrastive learning model based on a first training dataset for the first modality and the second modality; and providing the pre-trained first encoder in the pre-trained first contrastive learning model for a downstream task. Because only the model capacity of one encoder is increased in the pre-training stage, model performance may be improved without increasing model training overhead during downstream task fine-tuning and model running overhead during model application.

### CROSS REFERENCE TO RELATED APPLICATIONS

The present application claims priority to Chinese Patent Application No. 202211352406.7, titled “METHODS, APPARATUSES, DEVICE AND MEDIUM FOR CONTRASTIVE LEARNING,” filed on Oct. 31, 2022, the contents of which are hereby incorporated by reference in its entirety.

### FIELD

Embodiments of the present disclosure generally relate to machine learning, and in particular to methods, apparatuses, a device, and a computer-readable storage medium for contrastive learning.

### BACKGROUND

With the development of machine learning technology, machine learning models may already be used to perform tasks in various application environments. Cross-modal learning is a machine learning method that utilizes a correlation between multimodal data (such as images, videos, texts, audios, and so on) to learn representations of various modalities. In the process of contrastive learning, a contrastive learning model consisting of multiple modalities of encoders may be constructed. The model training is completed based on a contrastive learning loss function using the training data, so that encoders for different modalities are obtained for feature extraction of different modalities of data.

### SUMMARY

In a first aspect of the present disclosure, a method of contrastive learning is provided. The method comprises: determining, based on a model construction criterion, a first encoder for a first modality and a second encoder for a second modality; constructing a first contrastive learning model, the first contrastive learning model comprising the first encoder and a third encoder for the second modality, and a model capacity of the third encoder being greater than a model capacity of the second encoder; performing pre-training of the first contrastive learning model based on a first training dataset for the first modality and the second modality; and providing the pre-trained first encoder in the pre-trained first contrastive learning model for a downstream task.

In a second aspect of the present disclosure, a method of encoder application is provided. The method comprises: obtaining a first encoder for a first modality provided according to the method of the first aspect; and running the first encoder in a downstream task.

In a third aspect of the present disclosure, an apparatus for contrastive learning is provided. The apparatus comprises: an encoder determining module configured to determine, based on a model construction criterion, a first encoder for a first modality and a second encoder for a second modality; a first model constructing module configured to construct a first contrastive learning model, the first contrastive learning model comprising the first encoder and a third encoder for the second modality, and a model capacity of the third encoder being greater than a model capacity of the second encoder; a pre-training module configured to perform pre-training of the first contrastive learning model based on a first training dataset for the first modality and the second modality; and an encoder providing module configured to provide the pre-trained first encoder in the pre-trained first contrastive learning model for a downstream task.

In a fourth aspect of the present disclosure, an apparatus for encoder application is provided. The apparatus comprises: an encoder obtaining module configured to obtain a first encoder for a first modality provided according to the method of the first aspect; and an encoder applying module configured to apply the first encoder in a downstream task.

In a fifth aspect of the present disclosure, an electronic device is provided. The device comprises at least one processing unit; and at least one memory coupled to the at least one processing unit and storing instructions executable by the at least one processing unit, the instructions, when executed by the at least one processing unit, causing the device to perform the method of the first aspect and/or the second aspect.

In a sixth aspect of the present disclosure, a computer-readable storage medium is provided. The medium has a computer program stored thereon which, when executed by a processor, performs the method according to the first aspect and/or the second aspect.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1A illustrates a schematic diagram of an example environment in which the embodiments of the present disclosure may be implemented;

FIG. 1B illustrates a schematic diagram of a cross-modal contrastive learning process;

FIG. 2 illustrates a block diagram of a structure of a process for contrastive learning according to some embodiments of the present disclosure;

FIG. 3 illustrates a block diagram of a structure of a machine learning model based on contrastive learning according to some embodiments of the present disclosure;

FIG. 4A illustrates a schematic diagram of a contrastive learning architecture according to some embodiments of the present disclosure;

FIG. 4B illustrates a schematic diagram of a contrastive learning architecture according to some further embodiments of the present disclosure;

FIG. 5 illustrates a comparison between a scheme according to some embodiments of the present disclosure and conventional schemes in a cross-modal downstream task;

FIG. 6A illustrates a block diagram of an apparatus for contrastive learning according to some embodiments of the present disclosure;

FIG. 6B illustrates a block diagram of an apparatus for encoder application according to some embodiments of the present disclosure; and

FIG. 7 illustrates an electronic device in which one or more embodiments of the present disclosure may be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the term “including” and similar terms should be understood as open inclusion, that is, “including but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

It is understandable that the data involved in this technical proposal (including but not limited to the data itself, data acquisition or use) shall comply with the requirements of corresponding laws, regulations and relevant provisions.

It is understandable that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementations, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It may be understood that the above notification and acquisition of user authorization process are only schematic and do not limit the implementations of the present disclosure. Other methods that meet relevant laws and regulations may also be applied to the implementation of the present disclosure.

As used in herein, the term “model” may learn a correlation between a corresponding input and output from training data, so that a corresponding output may be generated for a given input after a training is completed. Model generation may be based on machine learning technology. Deep learning is a machine learning algorithm that uses multiple layers of processing units to process input and provide corresponding output. A neural network model is an example of a deep learning-based model. In this article, a “model” may also be referred to as a “machine learning model”, a “learning model”, a “machine learning network”, or a “learning network”, and these terms are used interchangeably in this article.

A “neural network” is a machine learning network based on deep learning. The neural network may process input and provide corresponding output, which typically including input and output layers, and one or more hidden layers between the input and output layers. A neural network used in a deep learning application typically includes many hidden layers to increase the depth of the network. Respective layers of a neural network are sequentially connected, so that output of a previous layer is provided as input to a subsequent layer. The input layer receives input of the neural network, while output of the output layer serves as final output of the neural network. Each layer of the neural network includes one or more nodes (also referred to as processing nodes or neurons), and each node processes input from a previous layer.

Usually, machine learning may roughly include three stages, namely a training stage, a testing stage, and an application stage (also referred to as an inference stage). During the training stage, a given model may be trained using a large amount of training data, iteratively updated parameter values until the model may obtain consistent inference that meets an expected goal from the training data. Through the training, the model may be considered to be able to learn the correlation between input and output (also referred to as input to output mapping) from the training data. The parameter values of the trained model are determined. In the testing stage, test input is applied to the trained model to test whether the model may provide correct output, thereby determining the performance of the model. In the application stage, the model may be used to process actual input and determine corresponding output based on the parameter values obtained through training.

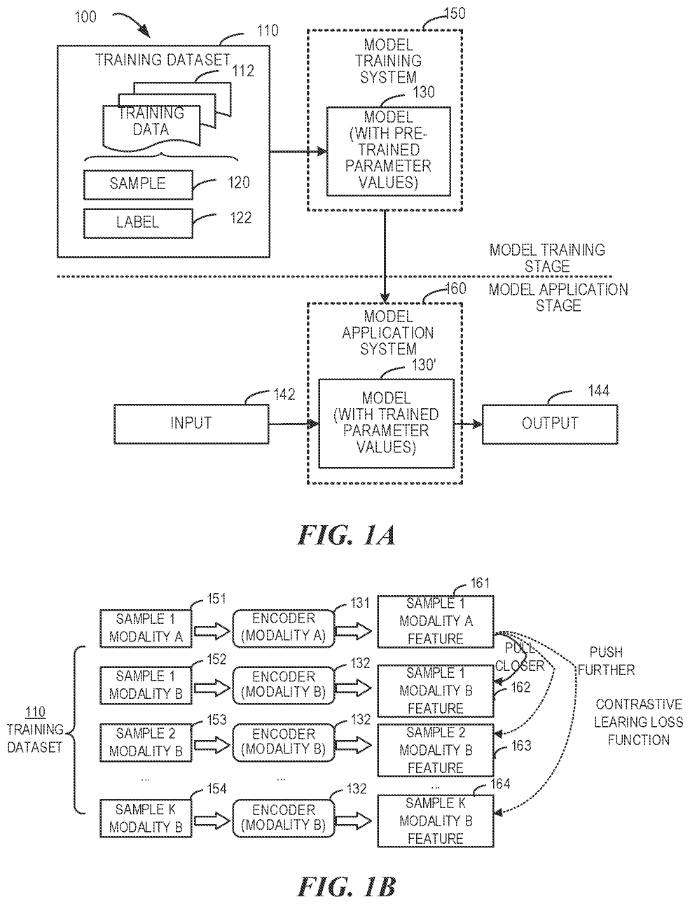

FIG. 1A illustrates a block diagram of an example environment 100 in which the embodiments of the present disclosure may be implemented. In the environment 100 of FIG. 1A, it is expected to train and use such a machine learning model (that is, a model 130), which is configured for various application environments, for example, for recognizing image content, and so on. As shown in FIG. 1A, the environment 100 includes a model training system 150 and a model application system 160. The upper part of FIG. 1A shows a process of a model training stage, and the lower part shows a process of a model application stage. Before training, parameter values of the model 130 may have initial values or have pre-trained parameter values obtained through a pre-training process. The model 130 may be trained through forward and backward propagation, and the parameter values of the model 130 may be updated and adjusted during a training process. After the training is completed, a model 130′ may be obtained. At this point, parameter values of the model 130′ have been updated, and based on the updated parameter values, the model 130 may be used to achieve a prediction task during the model application stage.

In the model training stage, the model 130 may be trained based on a training dataset 110 including a plurality of training data 112 and using the model training system 150. Here, each training data 112 may involve a 2-tuple format and include a sample 120 and a label 122 related to a pending task. At this point, the model 130 may be trained using the training data 112 including the sample 120 and the label 122. Specifically, a large amount of training data may be utilized to execute the training process iteratively. After the training is completed, the model 130 may include knowledge related to the pending task. In the model application stage, the model application system 160 may be used to call the model 130′ (at this time, the model 130′ has trained parameter values). For example, input 142 to be processed by the model may be received and a corresponding answer to the pending task (that is, output 144) may be output.

In FIG. 1A, the model training system 150 and the model application system 160 may include any computing systems with computing capability, such as various computing devices/systems, terminal devices, servers, and so on. The terminal device may involve any type of mobile terminal, fixed terminal or portable terminal, including a mobile phone, a desktop computer, a laptop computer, a notebook computer, a netbook computer, a tablet computer, a media computer, a multimedia tablet, or any combination of the foregoing, including accessories and peripherals of these devices or any combination thereof. Servers include but are not limited to mainframes, edge computing nodes, computing devices in cloud environments, and so on.

It should be understood that the components and arrangements shown in the environment 100 of FIG. 1A are only examples, and a computing system suitable for implementing the example implementation described in the present disclosure may include one or more different components, other components, and/or different arrangements. For example, although shown as separate, the model training system 150 and the model application system 160 may be integrated into a same system or device. The implementation of the present disclosure is not limited in this regard. The following will continue to refer to the accompanying drawings to describe example implementation for model training and model application.

In some applications, the model 130 to be trained may include a contrastive learning model for multi-modality. The contrastive learning model may be constructed to include different encoders for different modalities, for learning feature representations for different modality data. FIG. 1B illustrates a schematic diagram of a cross-modal contrastive learning process. It is assumed that the contrastive learning model includes an encoder 131 for a first modality (referred to as a “modality A”) and an encoder 132 for a second modality (referred to as a “modality B”). The encoder 131 and the encoder 132 are configured to perform feature extraction on the data for respective modalities, respectively.

The training dataset 110 includes a sample for the modality A and a sample for the modality B. During the training process, samples from respective modalities of the training dataset 131 are input into the encoder 131 or the encoder 132 for feature extraction. For example, a modality A feature 161 of a sample 1 is extracted from a sample 1 151 of the modality A through the encoder 131; a modality B feature 162 of a sample 1, a modality B feature 163 of a sample 2, and . . . a modality B feature 164 of a sample K are extracted from a sample 1 152 of the modality B, a sample 2 153 of the modality B, and . . . a sample K 154 of the modality B through the encoder 132 respectively. The label in the training dataset 110 indicates that the sample 1 151 of the modality A is related to the sample 1 152 of the modality B. For example, for cross-modal contrastive learning of images and text, the association between an image sample and a text sample may indicate that the text sample matches the image sample, and capable of describing the image sample, or vice versa.

For extracted feature representations, parameter values of an encoder may be updated by a contrastive learning loss function (for example, an InfoNCE loss function). In this process, the parameter values are updated by pulling features of positive sample pairs closer and pushing features of negative sample pairs further. In contrastive learning, a sample in one modality and a relevant sample in another modality may be constructed into a positive sample pair, such as the sample 1 151 of the modality A and the sample 1 152 of the modality B in FIG. 1B; negative samples are composed of other samples in a training sample set (for example, in a batch or a minibatch). For example, except for the sample 1 152 in the modality B, the sample 1 151 of the modality A and other samples of the modality B, for example the sample 2 153 of the modality B, . . . the sample K 154, and so on are all constructed into negative sample pairs. Therefore, based on the contrastive loss function, the modality A feature 161 of the sample 1 and the modality B feature 162 of the sample 1 may be pulled closer and the modality A feature 161 of the sample 1 and the modality B feature 163 of the sample 2, . . . the modality B feature 164 of the sample K, and so on may be pushed further by updating the parameter values of the encoder 131 and the encoder 132.

Note that in the following, for the convenience of discussion, a cross-modal contrastive learning model for two modalities will be discussed. However, it should be understood that the embodiments of the present disclosure may be applied to a contrastive learning model for more modalities similarly.

The model obtained through cross-modal contrastive learning has different applications in different application scenarios. In an application scenario, an encoder for a single modality in a contrastive learning model is provided for feature extraction of single modality data in a downstream task. At this point, cross-modal contrastive learning may be considered as in the pre-training stage. In a downstream task, the encoder may further be fine-tuned for a single modality task. In another application scenario, an encoder for two modalities is provided for a downstream correlation task for cross-modal, such as determining whether data of a first modality is related to data of a second modality. For example, in cross-modal learning for image data and text data, the obtained image encoder and text encoder are provided for image and text retrieval to determine whether an image and text match each other. In a cross-modal downstream task, the encoder may further be fine-tuned or not.

In general, if better model performance is required for a downstream task, it is necessary to construct an encoder with a larger model capacity in upstream cross-modal contrastive learning. Therefore, currently, regardless of whether a downstream task is used for a single modality or a dual modality, increasing the model capacity of the encoder in cross-modal learning may be chosen. However, directly increasing the model capacity may introduce significant computational resource overhead and memory overhead at each stage. In addition, for certain tasks, directly increasing the model capacity may not bring significant effects.

According to example embodiments of the present disclosure, an improved scheme for contrastive learning is provided. Specifically, in the upstream cross-modal contrastive learning process, a model capacity of an encoder for one modality is increased intentionally. A larger encoder for one modality and a normal encoder for another modality are used for pre-training. The performance of an encoder with a normal model capacity can be significantly improved by pre-training together with an encoder with a larger model capacity. The encoder with a normal model capacity is provided for a downstream task. Because only the model capacity of one encoder is increased in the pre-training stage, model performance may be improved without increasing model training overhead during downstream task fine-tuning and model running overhead during model application.

Some example embodiments of the present disclosure will be described in the following with reference to the accompanying drawings.

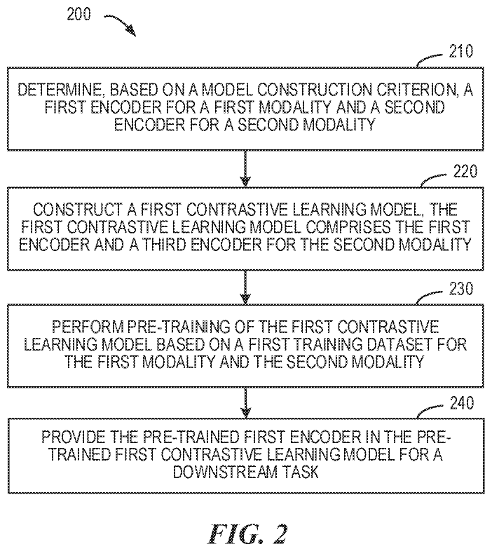

FIG. 2 illustrates a flowchart of a process 200 for contrastive learning according to some embodiments of the present disclosure. The process 200 may be implemented at the model training system 150. For the convenience of discussion, the process 200 will be described with reference to the environment 100 in FIG. 1.

At block 210, the model training system 150 determines, based on a model construction criterion, a first encoder for a first modality and a second encoder for a second modality.

In some embodiments, the first modality may comprise any of the following modalities: an image, text, a video, audio, and the second modality may comprise a further one of the modalities. It will be understood that the first modality may be described below as an image and the second modality as text as an example. Alternatively, or in addition, the first modality and the second modality may be exchanged with each other. Alternatively, or in addition, the first modality and the second modality may further involve the same data format, for example, both of the modalities may involve images in the image processing (for example, cropping, flipping, or the like) environment. According to the example embodiments of the present disclosure, the first modality and the second modality may further involve other formats, including but not limited to an image, text, a video, audio, and the like.

The encoder herein may be also referred to as a feature extractor, which is configured to extract a feature for an input corresponding to a modality. The encoder for the first modality and the encoder for the second modality may be selected as machine learning models or neural networks suitable for processing data of the corresponding modalities. The model construction criterion may be based on a model type, a model size, a connection relationship of respective layers, the processing functions applied by the model units, or the like that are applicable to the cross-modal contrastive learning model. The model construction criterion used in different applications may be different. In general, for different modalities and for a cross-modal correlation task, encoders for different modalities may be constructed to have a capacity matching the model. For example, in cross-modal learning for images and text, Res50 encoder may be selected as an encoder for an image modality, while BERT-Base encoder may be selected as an encoder for a text modality.

At block 220, the model training system 150 constructs a first contrastive learning model, the first contrastive learning model comprises the first encoder and a third encoder for the second modality, and a model capacity of the third encoder is greater than a model capacity of the second encoder.

In the embodiment of the present disclosure, in a case where encoders for different modalities are selected in a general model construction criterion, an encoder for one modality (for example, the first encoder for the first modality) is maintained to use, and the model capacity of an encoder for a further modality (for example, the second encoder for the second modality) is increased intentionally. The third encoder in the constructed first contrastive learning model may be considered as an enhanced version of the second encoder.

In some embodiments, the model capacity of an encoder may be based on the amount of parameter values of the encoder. For example, if the encoder has more processing layers (or network layers) and connections between processing layers and processing units are more complex, more parameters are needed to characterize the encoder. Alternatively, or in addition, the model capacity of the encoder may further be based on the complexity of the encoder and/or the amount of computation of the encoder. For example, if a more complex and computationally intensive processing function is chosen, the model capacity of the encoder will be considered larger.

It is generally understood that an increase in the model capacity may require more storage space to store parameter values of the model and more computing resources to deal with more complex and large-scale model processing. During the training process, more storage and computing resources are needed to deal with frequent model processing and parameter value updates.

It is noted that the third encoder for the second modality and the second encoder for the second modality may be a same type of model or different types of models, as long as they can be distinguished from each other by the model capacity.

In some embodiments, if it is determined that the first encoder for the first modality needs to be provided for a downstream task, then a further modality (that is, the model capacity of the encoder for the second modality) may be chosen to enhance.

As some examples, in cross-modal learning for images and text, it is assumed that based on the model construction criterion, the Res50 encoder may be chosen as an encoder for an image modality, while the BERT-Base encoder may be chosen as an encoder for a text modality. If the text modality is to be enhanced, a RoBERT-Large encoder may be chosen to construct a contrastive learning model. If the image modality is to be enhanced, a Vi-Base encoder may be chosen.

At block 230, the model training system 150 performs pre-training of the first contrastive learning model based on a first training dataset for the first modality and the second modality.

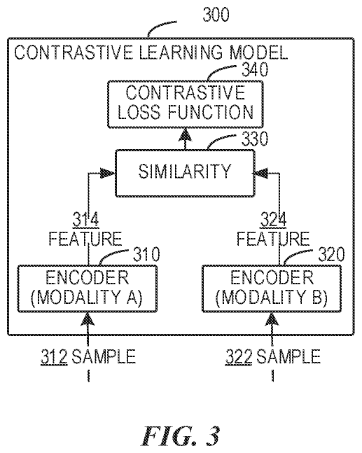

For a contrastive learning model with an enhanced encoder for one modality, pre-training of the model may be performed using training data. For convenience of understanding, a general cross-modal contrastive learning process will be described in combination with FIG. 3.

FIG. 3 illustrates a block diagram of a structure of a machine learning model based on contrastive learning according to some embodiments of the present disclosure. As shown in FIG. 3, a contrastive learning model 300 may include two encoders, an encoder 310 for the first modality (modality A) and an encoder 320 for the second modality (the modality B). During the pre-training process, a sample 312 for the modality A and a sample 322 for the modality B may be input to the encoder 310 and the encoder 320, respectively. The sample 312 and the sample 322 are referred to as a pair of samples (referred to as a sample pair) for contrastive learning. The encoder 310 and the encoder 320 extract a feature 314 and a feature 324 of the sample 312 and the sample 322, respectively. A feature may be represented in a multidimensional vector format. Herein, the “feature” may also be referred to as an input representation, encoding representation, vector representation, or the like. The contrastive learning model 300 will determine the similarity 330 between two features, thereby determining a contrastive loss function 340. For example, the similarity between the features may be computed using any method that may characterize the similarity between vectors. For example, the contrastive loss function 340 may be the InfoNCE loss function or other contrastive loss function.

In the process of contrastive learning, the encoder 310 and the encoder 320 may be gradually optimized, based on the contrastive loss function 340, by learning from pulling features of positive sample pairs (that is, sample pairs that are labeled as mutually related) closer and pushing features of negative sample pairs (that is, sample pairs that are not labeled as mutually related) further.

For example, in pre-training for the first contrastive learning model, matched samples in the training sample set may be constructed as positive sample pairs. N positive sample pairs may be sampled from the training sample set to construct a training batch. For each sample pair (x_{i(A)}, x_{i(B)}) in the training batch, x_{i(A)} represents a sample for the modality A and x_{i(B)} represents a sample for the modality B. The sample x_{i(A)} is input into the encoder of the modality A to extract a feature s_{i(A)}=f_{A}(x_{i(A)}), where f_{A}( ) represents the first encoder for the modality A. The sample x_{i(B)} is input into the third encoder for the modality B to extract a feature s_{i(B+)}=f_{B}+(x_{i(B)}), where f_{B+}( ) represents the third encoder for the modality B.

For the features (s_{i(A)}, s_{i(B+)}) of matched sample pairs in a training batch, the other N−1 samples may be served as negative samples of the current samples to calculate contrastive learning losses, so that the similarity between features of related sample pairs, that is (s_{i(A)}, s_{i(B+)}), is higher, while the similarity between features of unrelated sample pairs, that is (s_{i(A)}, s_{≠i(B+)}) and (s_{≠i(A)}, s_{i(B+)}), is lower. The losses of all samples in the current training batch may be averaged, and the parameter values of the encoder may be updated through a stochastic gradient descent algorithm until a convergence goal is achieved.

For the first contrastive learning model, the first encoder for the first modality and the third encoder for the second modality may be pre-trained with reference to the contrastive learning process described in FIG. 3, thereby obtaining a pre-trained first contrastive learning model. In the pre-trained first contrastive learning model, parameter values of the pre-trained first encoder and second encoder are updated and converged to a training target.

Continuing with reference to FIG. 2, at block 240, the model training system 150 provides the pre-trained first encoder in the pre-trained first contrastive learning model for a downstream task.

In the embodiments of the present disclosure, although an encoder in one modality is enhanced, the encoder is used to assist an encoder in a further modality for training. In this way, in a cross-modal task, an encoder with a larger model capacity is introduced to cooperate with a migration strategy which may significantly improve feature representation capability of the encoder in a further modality. In this way, the first encoder will have a better starting point in a downstream task. The encoder with a larger model capacity is only used in the pre-training stage, and although overhead of the pre-training stage is increased, the downstream task and overhead of model application stage may not be affected.

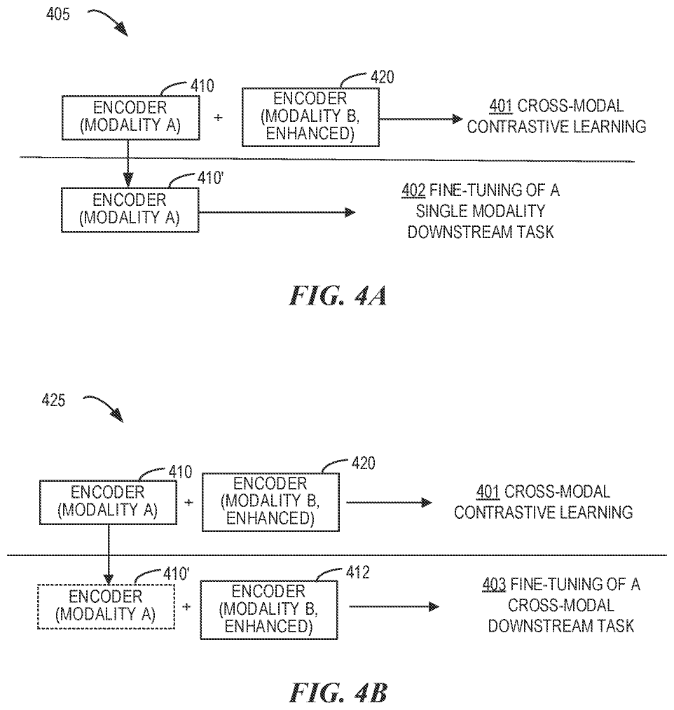

In some embodiments, the downstream task may comprise a single-modality downstream task for the first modality. FIG. 4A illustrates a schematic diagram of a contrastive learning architecture 405 according to some embodiments of the present disclosure. In this example, the first contrastive learning model comprising an encoder 410 and an enhanced encoder 420 is constructed. In the pre-training stage, the pre-trained first contrastive learning model is obtained through cross-modal contrastive learning 401, and a pre-trained encoder 410′ for the first modality is provided for a single-modality downstream task. In some embodiments, in the downstream task, fine-tuning 402 of the single modality downstream task may be performed based on the needs of the single modality downstream task, to fine-tune parameter values of the pre-trained encoder 410′. There are no restrictions in this regard in this article.

The enhanced encoder in the modality B may significantly improve feature learning of an encoder in a further modality A, so that the encoder for the modality A may obtain a better starting point for fine-tuning in a downstream task. Compared with a conventional scheme, model capacity of the encoder for the modality A may be the same, however parameter values are adjusted to a better extent in the pre-training stage. Therefore, if fine-tuning for the downstream task is required, training time of the encoder for the modality A will not increase. In addition, the encoder for the modality A can provide a better predictive capability even when directly used for the downstream task. Such a pre-training method may significantly improve the performance of the encoder without increasing training overhead during downstream fine-tuning and subsequent model application overhead.

In some embodiments, the downstream task may comprise a cross-modal downstream task for the first modality and the second modality. The execution of the cross-modal downstream task requires encoders for two modalities. In some embodiments, instead of directly using the pre-trained first encoder and the third encoder, the second encoder with a lower model capacity is chosen for the second modality. In other words, suppose that it is known that contrastive learning is to be carried out for the cross-modal downstream task, and it has been determined that the first encoder for the first modality and the second encoder for the second modality are to be chosen for the cross-modal downstream task. FIG. 4B illustrates a schematic diagram of a contrastive learning architecture 425 according to some further embodiments of the present disclosure. As shown in FIG. 4B, after the pre-training stage, a second contrastive learning model used for the cross-modal downstream task comprises the encoder 410 and an encoder 412. Correspondingly, in order to improve performance, the encoder 412 may be chosen to enhance to be the encoder 420 in the pre-training stage. That is, the encoder 420 will have a larger model capacity than the encoder 412. In the cross-modal contrastive learning 401 stage, pre-training is conducted on the encoder 410 and the encoder 420 using the training dataset.

Afterwards, the second contrastive learning model may be continuously constructed, which comprises the pre-trained first encoder and the second encoder, that is, the pre-trained encoder 410′ and the encoder 412 with a lower model capacity. Then, fine-tuning 403 of the cross-modal downstream task may be performed on the second contrastive learning model. After training, the encoder 410′ and the trained encoder 412 may be provided for using in the cross-modal downstream task.

In the training stage, training of the second contrastive learning model may be performed based on a second training dataset for the first modality and the second modality. Parameter values of the pre-trained encoder 410′ are not updated in the fine-tuning 403 of the cross-modal downstream task. Specifically, in a gradient descent-based training scheme, gradient backpropagation of the parameter values of the pre-trained encoder 410 is blocked. In this way, an erroneous parameter update resulting in a decrease in the performance of the pre-trained encoder 410′ may be avoided in the fine-tuning process of the cross-modal downstream task. At the same time, efficiency of fine-tuning the downstream task is accelerated. Therefore, at this time, only parameter values of the encoder 412 need to be updated (for example, performing gradient calculations).

Specifically, after constructing the second contrastive learning model of the pre-trained encoder 410′ and the encoder 412, N positive sample pairs are sampled from a second training sample set to construct a training batch. For each sample pair (x_{i(A)}, x_{i(B)}) in the training batch, x_{i(A)} represents a sample for the modality A and x_{i(B)} represents a sample for the modality B. The sample x_{i(A)} is input into the encoder of the modality A to extract a feature s_{i(A)}=f_{A}(x_{i(A)}), where f_{A}( ) represents the first encoder for the modality A. The sample x_{i(B)} is input into the second encoder for the modality B to extract a feature s_{i(B)}=f_{B}(x_{i(B)}), where f_{B}( ) represents the second encoder for the modality B.

For the features (s_{i(A)}, s_{i(B)}) of matched sample pairs in a training batch, the other N−1 samples may be served as negative samples of the current samples to calculate contrastive learning losses, so that the similarity between features of related sample pairs, that is (s_{i(A)}, s_{i(B)}), is higher, while the similarity between features of unrelated sample pairs, that is (s_{i(A)}, s_{≠i(B)}) and (s_{≠i(A)}, s_{i(B)}), is lower. The losses of all samples in the current training batch may be averaged, and the parameter values of the encoder may be updated through a stochastic gradient descent algorithm until a convergence goal is achieved. During the gradient backpropagation process, the gradient is not computed and gradient backpropagation is not performed for f_{A}( ) for the first encoder for the modality A.

The enhanced encoder in the modality B may significantly improve feature learning of an encoder in a further modality A, so that the learning of a further encoder for the modality B in the downstream may be further guided by a better modality A in the training process of the cross-modal downstream task, thus improving efficiency of the whole cross-modal learning and model performance. In addition, since the modality A does not participate in the gradient backpropagation during downstream training, the downstream training will take less time. Overall, such a model training scheme may improve training effectiveness and model performance while reducing downstream training time.

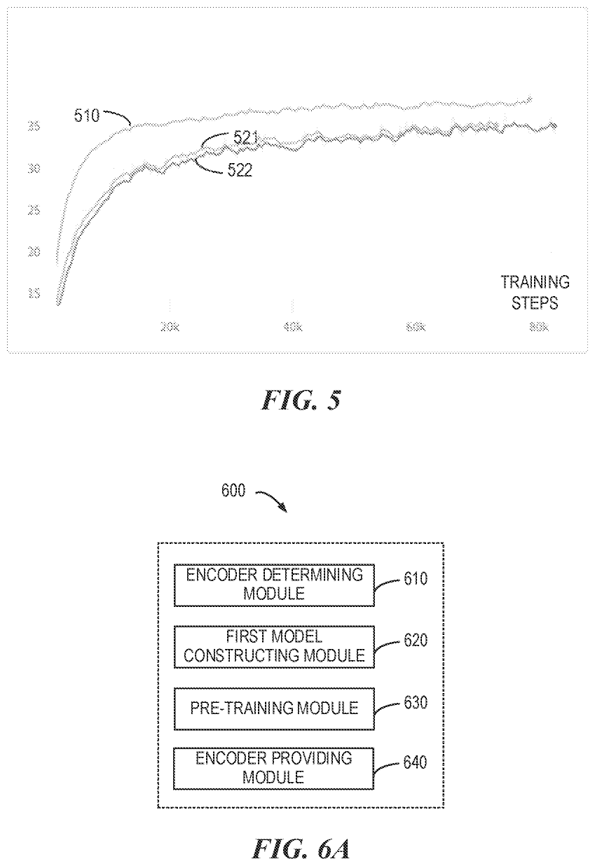

FIG. 5 illustrates a comparison between a scheme according to some embodiments of the present disclosure and conventional schemes in a cross-modal downstream task. It is assumed that the contrastive learning model constructed during the pre-training stage comprises a BERT-large encoder for a text modality and a ViT-base encoder for an image modality according to some embodiments of the present disclosure; in addition, the BERT-large encoder is fixed in the cross-modal downstream task and an EfficientNetV2 encoder with a lower model capacity is further trained for feature extraction of text modalities. In FIG. 5, the horizontal axis indicates training steps, and the vertical axis indicates model performance. A curve 510 of FIG. 5 indicates a performance curve in the training process according to some embodiments of the present disclosure. In a first conventional scheme, it is assumed that the BERT-large encoder and the EfficientNetV2 encoder are directly used for training, and a curve 521 indicates a performance curve in the training process of the scheme. In a second conventional scheme, it is assumed that the BERT-base encoder and the EfficientNetV2 encoder are directly used for training, and a curve 522 indicates a performance curve in the training process of the scheme. The comparison of these schemes is also summarized in the following Table 1:

TABLE 1

| | Text modality in | Image modality | Text modality in | Image modality |
|---|---|---|---|---|
| | pretraining | in pretraining | downstream | in downstream |
| Curve 510 | BERT-large | ViT-base | BERT-large (fixed) | EfficientNetV2 |
| Curve 521 | | | BERT-large | EfficientNetV2 |
| Curve 522 | | | BERT-base | EfficientNetV2 |

By comparing the curves in FIG. 5, it can be seen that the schemes according to some embodiments of the present disclosure not only converge faster (with fewer training steps), but also achieve higher performance. That is, both the model performance and training efficiency may be significantly improved.

In some embodiments, the encoder 410′ obtained from the aforementioned contrastive learning process may be provided for use in a downstream task, for example, in a single modality downstream task and/or a cross-modal downstream task (along with the trained encoder 412). For example, the application of the encoder may be executed by the model application system 160 in FIG. 1.

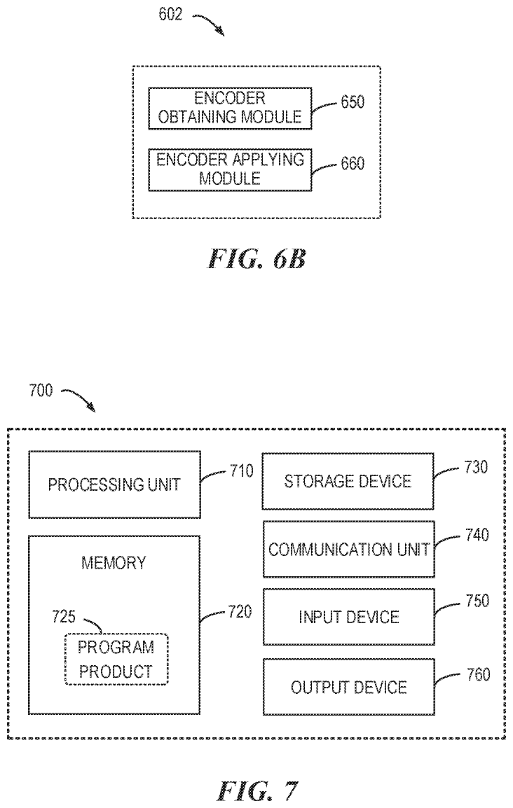

FIG. 6A illustrates a block diagram of an apparatus 600 for contrastive learning according to some embodiments of the present disclosure. The apparatus 600 may be implemented or included in the model training system 150, for example. Each module/component in the apparatus 600 may be implemented by hardware, software, firmware, or any combination thereof.

As shown in the figure, the apparatus 600 comprises an encoder determining module 610 configured to determine, based on a model construction criterion, a first encoder for a first modality and a second encoder for a second modality. The apparatus 600 further comprises a first model constructing module 620 configured to construct a first contrastive learning model, the first contrastive learning model comprising the first encoder and a third encoder for the second modality, and a model capacity of the third encoder being greater than a model capacity of the second encoder. The apparatus 600 further comprises a pre-training module 630 configured to perform pre-training of the first contrastive learning model based on a first training dataset for the first modality and the second modality. The apparatus 600 further comprises an encoder providing module 640 configured to provide the pre-trained first encoder in the pre-trained first contrastive learning model for a downstream task.

In some embodiments, the downstream task comprises a single-modal downstream task for the first modality.

In some embodiments, the downstream task comprises a cross-modal downstream task for the first modality and the second modality.

In some embodiments, the cross-modal downstream task is based on the first encoder and the second encoder. In some embodiments, the apparatus 600 further comprises: a second model constructing module configured to construct a second contrastive learning model, the second contrastive learning model comprising the pre-trained first encoder and the second encoder; and a training module configured to perform training of the second contrastive learning model based on a second training dataset for the first modality and the second modality.

In some embodiments, parameter values of the pre-trained first encoder are not updated in the training of the second contrastive learning model.

In some embodiments, gradient backpropagation of the parameter values of the pre-trained first encoder is blocked in the training of the second contrastive learning model.

In some embodiments, a model capacity of the third encoder and a model capacity of the second encoder are determined respectively based on at least one of the following: an amount of parameter values of the encoder, complexity of the encoder, or an amount of computation of the encoder.

In some embodiments, the first modality comprises any of the following modalities: an image, text, a video, audio, and the second modality comprises a further one of the modalities.

FIG. 6B illustrates a block diagram of an apparatus 602 for contrastive learning according to some embodiments of the present disclosure. For example, the apparatus 602 may be implemented or included in the model application system 160. Each module/component in the apparatus 602 may be implemented in hardware, software, firmware, or any combination thereof.

As shown in the figure, the apparatus 602 comprises an encoder obtaining module 650 configured to obtain a first encoder for a first modality provided according to some embodiments of the present disclosure or the apparatus 600. The apparatus 602 further comprises an encoder applying module 660 configured to apply the first encoder in a downstream task.

FIG. 7 illustrates a block diagram of an electronic device 700 in which one or more embodiments of the present disclosure may be implemented. It would be appreciated that the electronic device 700 shown in FIG. 7 is only an example and should not constitute any restriction on the function and scope of the embodiments described herein. The electronic device 700 shown in FIG. 7 may be used to implement the model training system 150 and/or the model application system 160.

As shown in FIG. 7, the electronic device 700 is in the form of a general computing device. The components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and can execute various processes according to the programs stored in the memory 720. In a multiprocessor system, multiple processing units execute computer executable instructions in parallel to improve the parallel processing capability of the electronic device 700.

The electronic device 700 typically includes a variety of computer storage medium. Such medium may be any available medium that is accessible to the electronic device 700, including but not limited to volatile and non-volatile medium, removable and non-removable medium. The memory 720 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 730 may be any removable or non-removable medium, and may include a machine-readable medium, such as a flash drive, a disk, or any other medium, which can be used to store information and/or data (such as training data for training) and can be accessed within the electronic device 700.

The electronic device 700 may further include additional removable/non-removable, volatile/non-volatile storage medium. Although not shown in FIG. 7, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 720 may include a computer program product 725, which has one or more program modules configured to perform various methods or acts of various embodiments of the present disclosure.

The communication unit 740 communicates with a further computing device through the communication medium. In addition, functions of components in the electronic device 700 may be implemented by a single computing cluster or multiple computing machines, which can communicate through a communication connection. Therefore, the electronic device 700 may be operated in a networking environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required. The external device, such as a storage device, a display device, etc., communicate with one or more devices that enable users to interact with the electronic device 700, or communicate with any device (for example, a network card, a modem, etc.) that makes the electronic device 700 communicate with one or more other computing devices. Such communication may be executed via an input/output (I/O) interface (not shown).

According to example implementation of the present disclosure, a computer-readable storage medium is provided, on which a computer-executable instruction or computer program is stored, wherein the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method of contrastive learning, comprising:
determining, based on a model construction criterion, a first encoder for a first modality and a second encoder for a second modality;
constructing a first contrastive learning model, the first contrastive learning model comprising the first encoder and a third encoder for the second modality, and a model capacity of the third encoder being greater than a model capacity of the second encoder;
performing pre-training of the first contrastive learning model based on a first training dataset for the first modality and the second modality; and
providing the pre-trained first encoder in the pre-trained first contrastive learning model for a downstream task.

2. The method of claim 1, wherein the downstream task comprises a single-modal downstream task for the first modality.

3. The method of claim 1, wherein the downstream task comprises a cross-modal downstream task for the first modality and the second modality.

4. The method of claim 3, wherein the cross-modal downstream task is based on the first encoder and the second encoder, the method further comprising:
constructing a second contrastive learning model, the second contrastive learning model comprising the pre-trained first encoder and the second encoder; and
performing training of the second contrastive learning model based on a second training dataset for the first modality and the second modality.

5. The method of claim 4, wherein parameter values of the pre-trained first encoder are not updated in the training of the second contrastive learning model.

6. The method of claim 5, wherein gradient backpropagation of the parameter values of the pre-trained first encoder is blocked in the training of the second contrastive learning model.

7. The method of claim 1, wherein a model capacity of the third encoder and a model capacity of the second encoder are determined respectively based on at least one of the following:
an amount of parameter values of the encoder,
complexity of the encoder, or
an amount of computation of the encoder.

8. The method of claim 1, wherein the first modality comprises any of the following modalities: an image, text, a video, audio, and the second modality comprises a further one of the modalities.

9. A method of encoder application, comprising:
obtaining a first encoder for a first modality provided according to a method of contrastive learning; and
running the first encoder in a downstream task;
the method of contrastive learning comprising:
determining, based on a model construction criterion, a first encoder for a first modality and a second encoder for a second modality;
constructing a first contrastive learning model, the first contrastive learning model comprising the first encoder and a third encoder for the second modality, and a model capacity of the third encoder being greater than a model capacity of the second encoder;
performing pre-training of the first contrastive learning model based on a first training dataset for the first modality and the second modality; and
providing the pre-trained first encoder in the pre-trained first contrastive learning model for a downstream task.

10. The method of claim 9, wherein the downstream task comprises a single-modal downstream task for the first modality.

11. The method of claim 9, wherein the downstream task comprises a cross-modal downstream task for the first modality and the second modality.

12. The method of claim 11, wherein the cross-modal downstream task is based on the first encoder and the second encoder, the method further comprising:
constructing a second contrastive learning model, the second contrastive learning model comprising the pre-trained first encoder and the second encoder; and
performing training of the second contrastive learning model based on a second training dataset for the first modality and the second modality.

13. The method of claim 12, wherein parameter values of the pre-trained first encoder are not updated in the training of the second contrastive learning model.

14. The method of claim 13, wherein gradient backpropagation of the parameter values of the pre-trained first encoder is blocked in the training of the second contrastive learning model.

15. The method of claim 9, wherein a model capacity of the third encoder and a model capacity of the second encoder are determined respectively based on at least one of the following:
an amount of parameter values of the encoder,
complexity of the encoder, or
an amount of computation of the encoder.

16. The method of claim 9, wherein the first modality comprises any of the following modalities: an image, text, a video, audio, and the second modality comprises a further one of the modalities.

17. An electronic device, comprising:
at least one processing unit; and
at least one memory coupled to the at least one processing unit and storing instructions executable by the at least one processing unit, the instructions, when executed by the at least one processing unit, causing the device to perform a method of contrastive learning comprising:
determining, based on a model construction criterion, a first encoder for a first modality and a second encoder for a second modality;
constructing a first contrastive learning model, the first contrastive learning model comprising the first encoder and a third encoder for the second modality, and a model capacity of the third encoder being greater than a model capacity of the second encoder;
performing pre-training of the first contrastive learning model based on a first training dataset for the first modality and the second modality; and
providing the pre-trained first encoder in the pre-trained first contrastive learning model for a downstream task.

18. The device of claim 17, wherein the downstream task comprises a single-modal downstream task for the first modality.

19. The device of claim 17, wherein the downstream task comprises a cross-modal downstream task for the first modality and the second modality.

20. The device of claim 19, wherein the cross-modal downstream task is based on the first encoder and the second encoder, the method further comprising:
constructing a second contrastive learning model, the second contrastive learning model comprising the pre-trained first encoder and the second encoder; and
performing training of the second contrastive learning model based on a second training dataset for the first modality and the second modality.
